(19) United States
(12) Patent Application Publication
(10) Pub. No.: US 2007/0073657 A1
(43) Pub. Date: Mar. 29, 2007

(54) Apparatus and method for utilizing a materialized query table in a computer database system

(75) Inventor: John M. Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/239,614

(22) Filed: Sep. 29, 2005

(51) Int. Cl. G06F 17/30

(52) U.S. Cl. 707/3

(57) ABSTRACT

An apparatus and method to utilize MQTs in a more efficient manner a computer database to improve database performance and utility. In preferred embodiments, the query optimizer determines if a valid but non-refreshed MQT exists and rewrites a query to operate over the MQT and over the base tables and then joins the results. In preferred embodiments, the query is rewritten to operate over base table results that are stored in a staging table prior to being used to refresh the MQT. In other embodiments, the query is rewritten to operate over the base tables on data records added since the last refresh.

### BACKGROUND OF THE INVENTION

1. Technical Field

This invention generally relates to computer database systems, and more specifically relates to apparatus and methods for utilizing a materialized query table in a computer database.

2. Background Art

Database systems have been developed that allow a computer to store a large amount of information in a way that allows a user to search for and retrieve specific information in the database. Data is typically stored in database tables. The tables contain columns and rows of data. The data in the table is related to or associated with other data in corresponding columns and rows. Relationships of the data are stored in indexes.

Retrieval of information from a database is typically done using queries. A database query typically includes one or more predicate expressions interconnected with logical operators. The database is searched for records that satisfy the query, and those records are returned as the query result. In database systems it is common for identical or closely related queries to be issued frequently. When a database contains very large amounts of data, certain queries against the database can take an unacceptably long time to execute. The cost of executing a query may be particularly significant when the query requires join operations among a large number of database tables.

It has become a common practice to store the results of often-repeated queries in database tables. By storing the results of queries, the costly join operations required to generate the results do not have to be performed every time the queries are issued. Rather, the database server responds to the queries by simply retrieving the pre-stored data. These stored results are sometimes referred to as a materialized views or materialized query tables (MQTs). The purpose for the MQT is to provide an aggregation of data that can satisfy many subsequent queries without repeating the full access to the database.

As new data is periodically added to the base tables of a materialized query table, the materialized query table needs to be updated to reflect the new base table data. When a materialized query table accurately reflects all of the data currently in its base tables, the materialized query table is considered to be “fresh”. Otherwise, the materialized query table is considered to be “stale”. A stale materialized query table may be re-computed by various techniques that are collectively referred to as a “refresh”. Some prior art systems use different modes to deal with data staleness. For example, software may access the MQT in an enforced mode, or some level of staleness-tolerated mode. When software accesses the data in Enforced mode, the data is required to be 100% accurate. If the MQT is not up to date when accessed in this mode, the data must be retrieved from the base tables rather than from the stale MQT.

In prior art databases, a query is sometimes broken into partial queries. A portion of the query is run against a base table or an unstale MQT, and a remaining portion of the query is satisfied by running it over other base tables. Retrieving the data from the base tables is more costly in system resources when an MQT could be used.

Without a way to satisfy a query against a stale MQT in an efficient manner, the computer industry will continue to suffer from inefficiency and poor database performance.

### DISCLOSURE OF INVENTION

In accordance with the preferred embodiments, an apparatus and method utilize MQTs in a more efficient manner in a computer database to improve database performance and utility. In preferred embodiments, the query optimizer determines if a valid but non-refreshed MQT exists and rewrites a query to operate over the MQT and over the base tables and then joins the results. In preferred embodiments, the query is rewritten to operate over base table results that are stored in a staging table prior to being used to refresh the MQT. In other embodiments, the query is rewritten to operate over the base tables on data records added since the last refresh.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is an apparatus in accordance with the preferred embodiments;

FIG. 2 is a table showing expressions that may be included in a predicate expression in a database query;

FIG. 3 is a sample database query in Structured Query Language (SQL);

FIG. 4 is a predicate expression that is representative of the WHERE clause in the sample database query of FIG. 3;

FIG. 5 is a table information block that is stored with a base table in the database according to preferred embodiments;

FIG. 6 is an MQT information block that is stored with an MQT according to preferred embodiments;

FIGS. 7 through 10 illustrate an example according to preferred embodiments;

FIGS. 11 through 13 illustrate another example according to preferred embodiments;

FIG. 14 is an example flow diagram of a method according to preferred embodiments;

FIG. 15 is an example flow diagram of a method according to preferred embodiments; and

FIG. 16 is an example flow diagram of a method according to preferred embodiments.

### BEST MODE FOR CARRYING OUT THE INVENTION

1.0 Overview

The present invention relates to an apparatus and method to efficiently utilize an MQT in a computer database to improve database performance and utility. For those not familiar with databases or queries, this Overview section provides background information that will help to understand the present invention.

### Known Databases and Database Queries

There are many different types of databases known in the art. The most common is known as a relational database (RDB), which organizes data in tables that have rows that represent individual entries or records in the database, and columns that define what is stored in each entry or record.

In a broader view, data in a database system is stored in one or more data containers, where each container contains records, and the data within each record is organized into one or more fields. In relational database systems, the data containers are referred to as tables, the records are referred to as rows, and the fields are referred to as columns as described above. In object oriented databases, the data containers are referred to as object classes, the records are referred to as objects, and the fields are referred to as attributes. Other database architectures may use other terminology. While not intended to be limiting to relational databases, for the purpose of explanation, the examples and the terminology used herein shall be that typically associated with relational databases. Thus, the terms “table”, “row” and “column” shall be used herein to refer respectively to the data container, record, and field and similarly apply to the other types of database containers.

Retrieval of information from a database is typically done using queries. A database query is an expression that is evaluated by a database manager. The expression may contain one or more predicate expressions that are used to retrieve data from a database. For example, lets assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix.

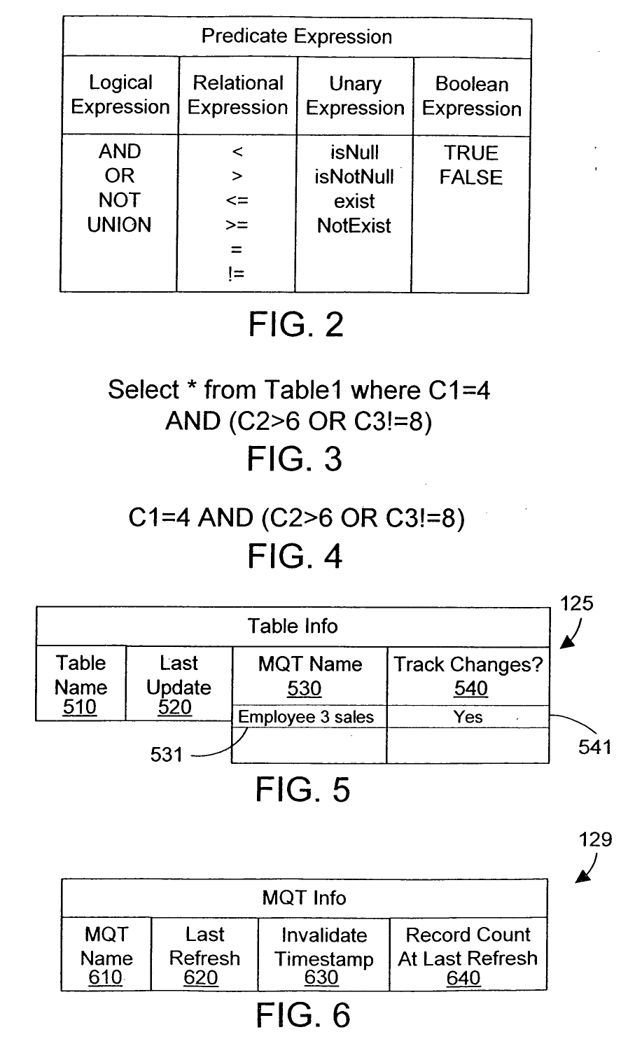

A database query typically includes one or more predicate expressions interconnected with logical operators. A predicate expression is a general term given to an expression using one of the four kinds of operators (or their combinations): logical, relational, unary, and boolean, as shown in FIG. 2. A query usually specifies conditions that apply to one or more columns of the database, and may specify relatively complex logical operations on multiple columns. The database is searched for records that satisfy the query, and those records are returned as the query result.

One popular way to define a query uses Structured Query Language (SQL). SQL defines a syntax for generating and processing queries that is independent of the actual structure and format of the database. One sample SQL query is shown in FIG. 3. The SELECT statement tells the database query processor to SELECT all columns, the “from Table 1” clause identifies which database table to search, and the WHERE clause specifies one or more expressions that must be satisfied for a record to be retrieved. Note that the query of FIG. 3 is expressed in terms of columns C1, C2 and C3. Information about the internal storage of the data is not required as long as the query is written in terms of expressions that relate to values in columns from tables.

For the query of FIG. 3, the WHERE clause specifies that the first column has a value equal to four (C1=4) logically ANDed with the expression that the second column is greater than six OR the third column is not equal to eight. The expression in the WHERE clause of FIG. 3 is shown in FIG. 4. Where not specifically stated herein, the term “expression” is intended to mean an arbitrary predicate expression, which can be an entire expression in a query, a portion of an expression in a query, or the entire query and may include logical expressions, relational expressions, unary expressions, boolean expressions, and their combinations.

In database systems it is common for identical or closely related queries to be issued frequently. To respond to such queries, the database server typically has to perform numerous join operations because the database records contain the information that is required to respond to the queries. When a database contains very large amounts of data, certain queries against the database can take an unacceptably long time to execute. The cost of executing a query may be particularly significant when the query (which takes the form of a “SELECT” statement in the SQL database language) requires join operations among a large number of database tables.

Materialized Query Tables

It has become a common practice to store the results of often-repeated queries in database tables or some other persistent database object. By storing the results of queries, the costly join operations required to generate the results do not have to be performed every time the queries are issued. Rather, the database server responds to the queries by simply retrieving the pre-stored data. These stored results are sometimes referred to as materialized views or materialized query tables (MQT). An MQT initially may be a computed result of a given query. The purpose for the MQT is to provide an aggregation of data that can satisfy many subsequent queries without repeating the full access to the database.

Typically, the query table definition is in the form of a database query, herein referred to as a materialized query. The materialized query is processed and the results are stored as the MQT. The results can be in the form of rows, which may be rows from a single base table or rows created by joining rows in the base table. Materialized query tables eliminate the overhead associated with gathering and deriving the data every time a query is executed. Through a process known as query rewrite, a query can be optimized to recognize and use existing materialized query tables that could answer the query. Typically, the query rewrite optimization is transparent to the application submitting the query. That is, the rewrite operation happens automatically and does not require the application to know about the existence of materialized query tables, nor that a particular materialized query table has been substituted in the original query.

Refreshing Materialized Query Tables

As new data is periodically added to the base tables corresponding to a materialized query table, the materialized query table needs to be updated to reflect the new base table data. When a materialized query table accurately reflects all of the data currently in its base tables, the materialized query table is considered to be “fresh”. Otherwise, the materialized query table is considered to be “stale”. A stale materialized query table may be re-computed by various techniques that are collectively referred to as a “refresh”.

The data in the MQT is either system maintained in real time or is deferred until the user specifies to refresh the table. Deferring the refresh is sometimes referred to as deferred maintenance. Making the decision whether to maintain the MQT in real time or in some deferred fashion is usually a business decision based upon available resources and the need for accurate data. In many systems, keeping MQT's up to date is not viable so different methods are used to initiate a refresh of the data. In these prior art systems the refresh is typically under software control by the user. Some prior art systems use different modes to tolerate data staleness. For example, software may access the MQT in an Enforced mode, and one or more modes that tolerate some amount of data staleness. When software accesses the data in Enforced mode, the data is required to be 100% accurate. If the MQT is not up to date when accessed in this mode, the data must be retrieved from the base tables rather than from the MQT. Retrieving the data from the base tables is more costly in system resources. In the preferred embodiments, the query optimizer is able to recognize some specific cases where the query can be rewritten to operate over the stale MQT and over the base tables in an efficient manner rather than running the query over the base tables to save system resources.

2.0 Detailed Description

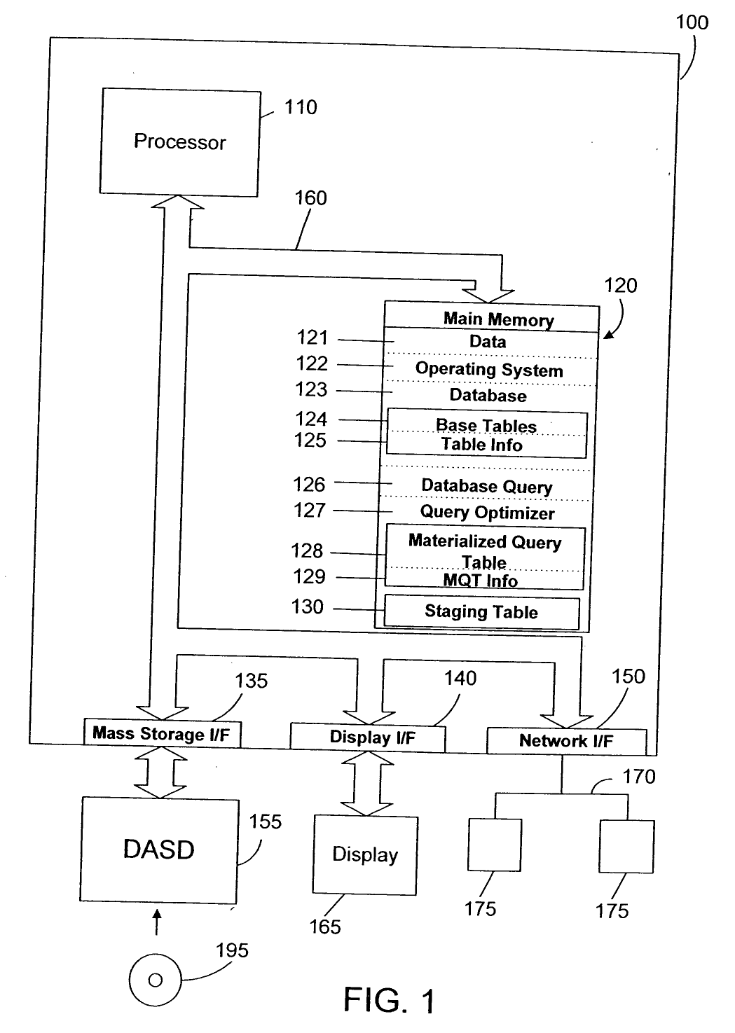

The preferred embodiments herein provide an apparatus and method to efficiently utilize an MQT in a computer database. Referring now to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 135, a display interface 140, and a network interface 150. These system components are interconnected through the use of a system bus 160. Mass storage interface 135 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 121, an operating system 122, and a database 123. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. Database 123 is any suitable database, whether currently known or developed in the future. Database 123 includes one or more base tables 124 with table info 125 as described further below. Memory 120 further comprises one or more database queries 126, and a database query optimizer 127. Database query 126 is a query in a format compatible with the database 123 that allows information stored in the database 123 that satisfies the database query 126 to be retrieved. Database query optimizer 127 optimizes a query 126 and produces an access plan used by a database manager (not shown) in the database 123 to access the database. Database query optimizer 127 includes a Materialized Query Table (MQT) 128 that is autonomically updated by the query optimizer 127 in accordance with the preferred embodiments. The MQT includes an MQT Info table 129 as described further below. Database query optimizer 127 further includes a staging table 130 that is used by the query optimizer 127 in accordance with the preferred embodiments. The staging table 130 temporarily stores data from queries that affect the MQT until the next refresh of the MQT is performed. The rows in the staging table are processed one at a time and removed from the staging table as they used to refresh the MQT.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, database query 126, and the database query optimizer 127 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 135, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD RW (e.g., 195 of FIG. 1), and transmission type media such as digital and analog communications links. Note that the preferred signal bearing media is tangible.

The preferred embodiments herein provide an apparatus and method to more efficiently utilize an MQT over prior art methods. In preferred embodiments, the query optimizer determines if a valid but non-refreshed MQT exists and rewrites a query to operate over the MQT and over the base tables on data records added since the last refresh and then joins the results. In other preferred embodiments, the query is rewritten to operate over base table results that are stored in a staging table prior to being used to refresh the MQT.

FIG. 5 shows table information 125 that is stored with a base table 124 according to preferred embodiments. The table information 125 includes a table name 510, and a timestamp of the last update 520 of the table. The table information 125 further includes a list of information about any MQTs that are associated with this base table. The list of MQT information includes the MQT name 530 and a track changes 540 field that indicates whether changes to the base table are being tracked for the corresponding MQT in the list.

FIG. 6 shows MQT information 129 that is stored with an MQT 128 according to preferred embodiments. The MQT information 129 includes an MQT name 610, a timestamp of the last refresh 620 of the MQT, an invalidate timestamp 630, and a record count at the time of the last refresh 640. The invalidate timestamp 630 is used by the query optimizer or a database engine to store a timestamp when the MQT becomes invalid. When the invalid timestamp 630 is zero, or some other special value, it would indicate that the MQT is not invalid. An MQT is determined to be invalid when there have been changes made to the base tables that have not been tracked in the staging table. The MQT is also determined to be invalid when the MQT is no longer able to provide current data in conjunction with a partial query to the base tables. For example, add and delete records to the base tables are changes where a partial query to the base tables joined with the MQT can provide current data so these operations on the base tables would not make the MQT invalid.

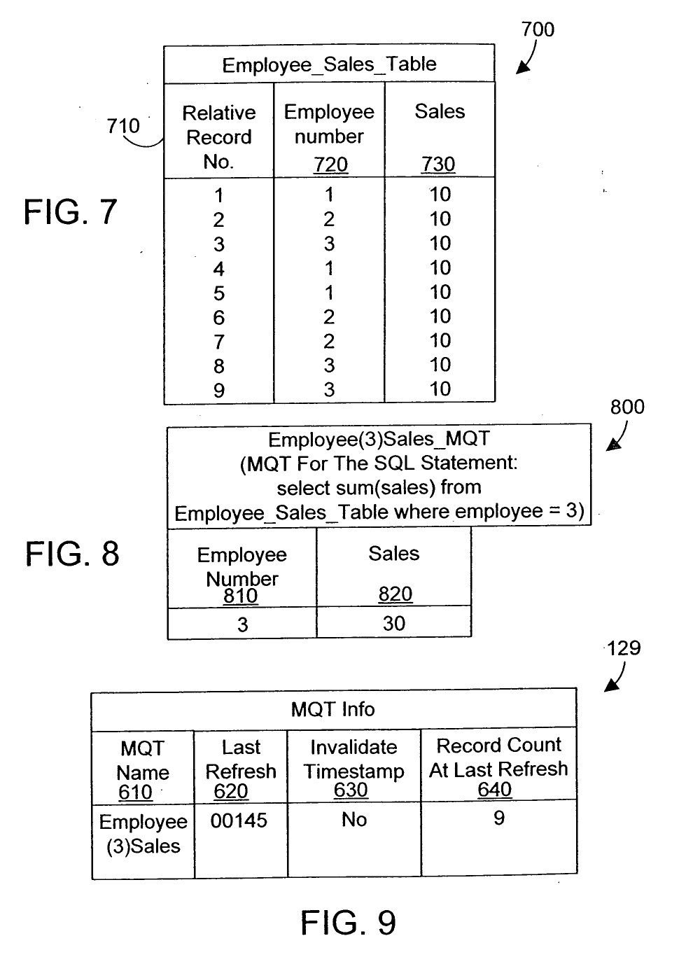

FIGS. 7 through 10 illustrate an example of query optimization according to preferred embodiments herein. FIG. 7 illustrates a sample data table 700 that holds data for this simplified example. The sample data table 700 represents one possible implementation of the base table 124 described with reference to FIG. 1. The sample data table 700 is titled Employee Sales Table and has columns that include the relative record number 710, an Employee number 720 and sales data 730.

With reference to the data shown in the sample data table 700, the query optimizer 127 may create an MQT for queries that are often encountered. For the illustrated example, the following query is processed by the query optimizer:
select sum (sales) from Employee_Sales_Table where employee_number=3
   In response to this query, the query optimizer creates the MQT shown in FIG. 8. The MQT 800 has an employee number of 3 (810) and the associated calculated data of the query, in this case the number of sales, 30, by employee number 3.

Referring now to FIG. 9, an MQT Info block 129 is shown for the MQT table in FIG. 9. The MQT Info block 129 is created by the query optimizer in conjunction with the creation of the MQT to store information about the MQT. The MQT Info block in the present example has the name of the MQT (employee 3 sales) 610, a timestamp for the last refresh (00145), an invalidate timestamp (no), and the record count at the last refresh (9) 640. The invalidate time stamp holds a “no” value or “false” value because the base table associated with the MQT has not been amended in a way that makes the MQT invalid for purposes of using the MQT to query for accurate data. For this example, the record count at the last refresh is assumed to be the record count of the MQT as shown in FIG. 7.

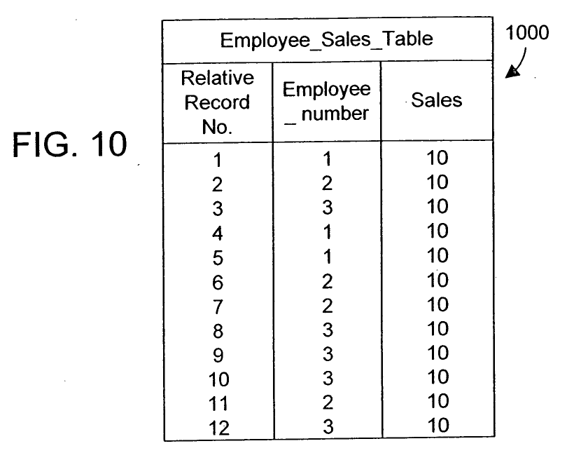

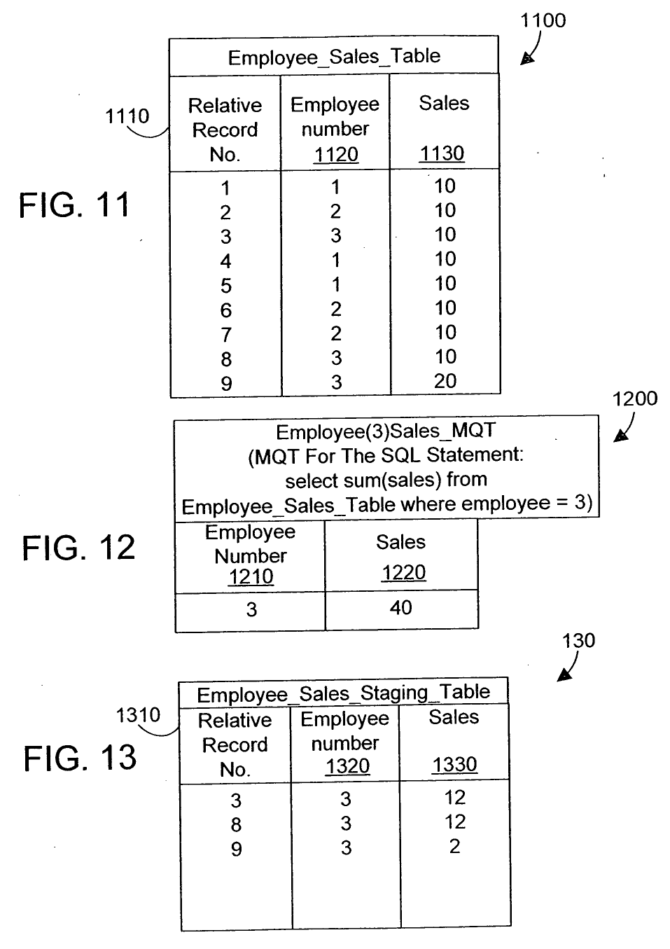

For the example shown in FIGS. 7 through 10, we now assume the base table is modified as shown in FIG. 10 by adding additional records with RRN's 10, 11, and 12. In this example, when the same query as before is processed by the query optimizer (select sum (sales) from Employee_Sales_Table where employee_number=3) the query optimizer will recognize the MQT has been modified since the last refresh by noting the number of records in the base table 1000 is greater than the record count at last refresh (9). Further the query optimizer 127 will recognize that the MQT is not invalid. The query optimizer could then proceed to modify the query to a more efficient query by running the original query over both the MQT and over the base tables (at least over the newly added portion of the base table). The query optimizer would rewrite the query as the join (sum) of the following two sub-queries:
select sales from Employee(3)Sales and
select sum (sales) from Employee_Sales_Table where employee_number=3 and rrn (Employee_Sales_Table)>9
   Using this modified query, the query optimizer has allowed the original query to run over a stale MQT, but provide results that are timely by also running the same query over the portion of the base table associated with the MQT that has been updated since the last refresh of the MQT.

FIGS. 11 through 13 illustrate another example of query optimization according to preferred embodiments herein. FIG. 11 illustrates a sample data table 1100 that holds data for this simplified example. The sample data table 1100 is titled Employee Sales Table and has columns that include the relative record number 1110, an Employee number 1120 and sales data 1130.

With reference to the data shown in the sample data table 1100, the query optimizer 127 may create an MQT for queries that are often encountered. For the illustrated example, the following query is processed by the query optimizer:
select sum (sales) from Employee_Sales_Table where employee_number=3
   In response to this query, the query optimizer creates the MQT shown in FIG. 12. The MQT 1200 has an employee number of 3 (1210) and the associated calculated data of the query, in this case the number of sales (1220), 40, by employee number 3.

Again referring to the Example of FIGS. 11 through 13, after the MQT is created, a subsequent query updates records to the base table shown in FIG. 11. We assume for this example that the following SQL statement is processed: UPDATE Employee_Sales_Table set sales=22 where employee_number=3. Since the MQT in this example is not being updating in real time, a staging table is created that looks as shown in FIG. 13. The staging table holds records similar to the Employee_Sales_Table shown in FIG. 11. However, the staging table records reflect the updates that took place during the update query. The information in the staging table reflects the difference between the value being updated and what was originally in the file. In this example, RRN's 3, 8 and 9 for employee 3 now show sales of 12, 12 and 2 respectively, which is the difference between the original value in the table shown in FIG. 11 and the value of 22 set by the query update.

In the example shown in FIG. 11 through 13, when the same query as before is processed by the query optimizer (select sum (sales) from Employee_Sales_Table where employee_number=3) the query optimizer will recognize the MQT has been modified since the last refresh by noting the presence of data in the staging table. Further the query optimizer 127 will recognize that the MQT is not invalid. The query optimizer could then proceed to modify the query to a more efficient query by running the original query over the MQT, and the staging table. The query optimizer would rewrite the query as the join (sum) of the following two sub-queries:
select sum(sales) from Employee(3)Sales MQT and
select sum(sales) from Employee_Sales_Staging_Table where employee_number =3
   Using this modified query, the query optimizer has allowed the original query to run over a stale MQT, but provide results that are timely by also running the same query over the staging table that has been updated since the last refresh of the MQT. In this example, the modified query gives a result of 66, which reflects the sales for employee 3 from the table shown in FIG. 11 (40) added to the sales in the staging table (12+12+2=26).

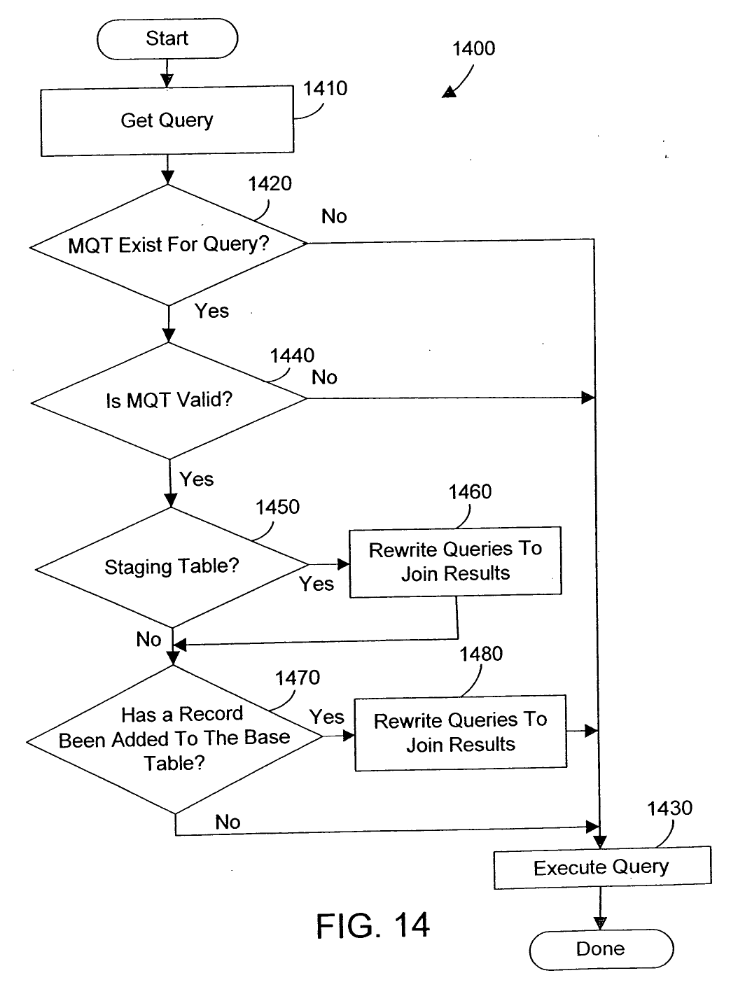

Referring now to FIG. 14, a flow diagram shows a method 1400 for efficiently using an MQT according to a preferred embodiment. The method 1400 is presented as a series of steps performed by a computer software program described above as a query optimizer 127. The query optimizer gets one or more queries that are sent for processing from software operating on the computer system (step 1410). The query optimizer parses the pending query to determine whether there is an existing MQT for the query (step 1420). If there is no corresponding MQT (step 1420=no) then the query optimizer proceeds to execute the query (step 1430). If there is a corresponding MQT for this query (step 1420, =yes) then the query optimizer proceeds to determine if the MQT is valid (step 1440). The MQT is not valid if changes were made to the base tables that were not tracked (see method 1500 below). If the MQT for the current query is not valid (step 1440=no) then the query optimizer proceeds to execute the query (step 1430). If the MQT for the current query is valid (step 1440=yes) then the query optimizer proceeds to check the staging table to determine if tracked changes to the base tables for the current MQT are stored (step 1450). If there is data stored in the staging table for the MQT (step 1450=yes) then the queries are rewritten to join the results of the query operating on the MQT and the staging table (step 1460). The method then continues with step 1470. If there is no data stored in the staging table for the MQT (step 1450=no) then the optimizer checks if a records have been added to the base tables that are tracked (step 1470). If records have been added (step 1470 yes) then the queries are rewritten to join the results of the MQT and the added records in the base table (step 1480). The method then continues by executing the query (step 1430). If a file has not been added (step 1470=no) then the method continues by executing the query (step 1430) and the method is then done.

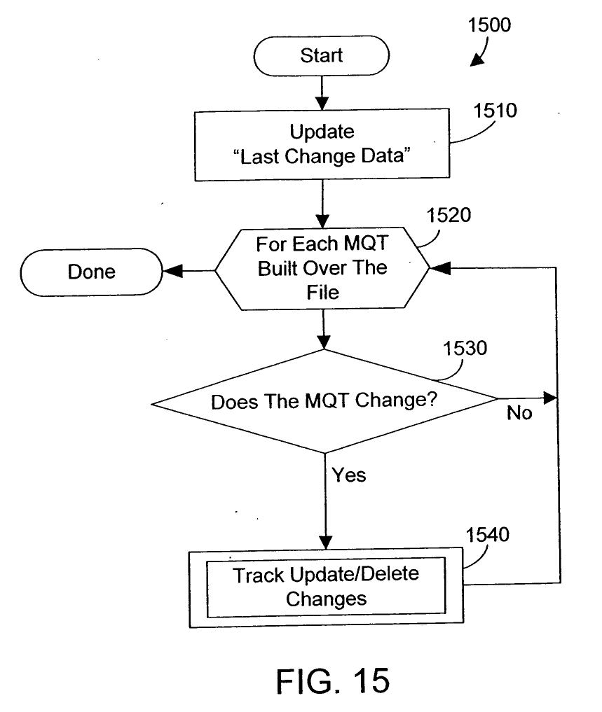

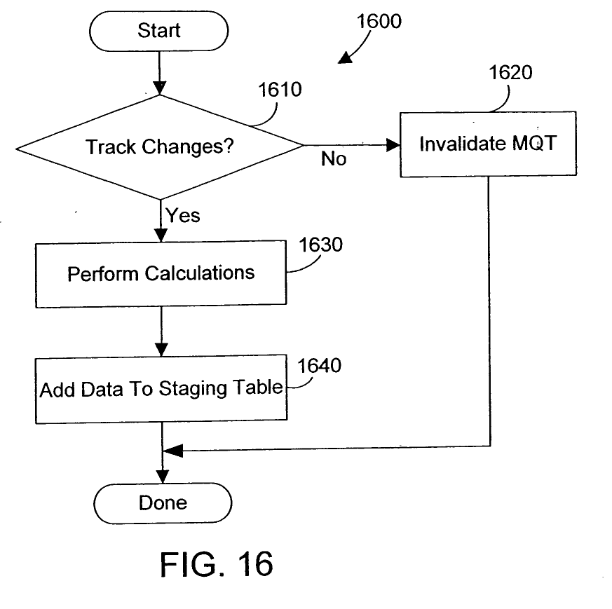

Referring now to FIG. 15, a flow diagram shows a method 1500 for tracking changes to base tables that have associated MQT's according to a preferred embodiment. Each time changes are made to a base table 124, the query optimizer 127 executes the steps of method 1500. Method 1500 is presented as a series of steps performed by a computer software program described above as a query optimizer 127. (The described steps could also be viewed as being performed by a database engine that performs database operations where the query optimizer is part of the database engine.) The method 1500 first updates the last update field 520 in the table info block 125 shown in FIG. 5 by storing a timestamp in the last update field 520 (step 1510). The method then performs a loop for each MQT built over the base table being updated (step 1520). For each MQT, if there is a change in the MQT (step 1530=yes) then the method executes the track update/delete changes routine (step 1540 and described with reference to FIG. 16). If there are no changes in the MQT (step 1530=no) then the method returns to the loop (step 1520) until each MQT is examined and then the method is done.

Referring now to FIG. 16, a flow diagram shows a method 1600 for tracking update/delete changes to base tables for the associated MQT's according to a preferred embodiment. Method 1600 is one suitable implementation of step 1540 of FIG. 14 in accordance with the preferred embodiments. The table info block 125 is first checked to see if changes are being tracked for the current MQT (step 1610). If changes are not being tracked for the current MQT (step 1610=no) then invalidate the current MQT (step 1620) by setting the invalidate timestamp 630 (shown in FIG. 6) in the MQT info block 129, and the method for the current MQT is then done. If changes are being tracked for the current MQT (step 1610=yes) then perform the calculations of the query (step 1630) and add the data from the calculations to the staging table (step 1640). The method is then done for the current MQT.

The present invention as described with reference to the preferred embodiments provides significant improvements over the prior art. The described apparatus and method provide an efficient utilization of an MQT in a computer database. The present invention provides a way to reduce database query time to improve system performance, and reduce excessive delays in database accesses.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a database residing in the memory having data in at least one base table; and
a query optimizer residing in the memory that optimizes queries that access the database, wherein the query optimizer rewrites a query as a join of a first sub-query and a second sub-query, wherein the first sub-query runs over a materialized query table (MQT) written over the base table and the second sub-query runs over the base table.

2. The apparatus of claim 1 wherein the query optimizer stores information concerning the base table that includes a list of MQT names and a field for each MQT name to indicate whether changes to the MQT are tracked by the query optimizer.

3. The apparatus of claim 2 wherein the query optimizer stores information concerning the MQT that includes an MQT name, a time the MQT was last refreshed, a timestamp that indicates when the MQT is invalid, and a field to indicate the record count of the base table associated with the MQT when the MQT was last refreshed.

4. The apparatus of claim 1 wherein the query optimizer runs the query over the base table records that have a relative record number greater than the record count associated with the MQT when the MQT was last refreshed.

5. An apparatus comprising:
at least one processor;
a memory coupled to the at least one processor;
a database residing in the memory having data in at least one base table; and
a query optimizer residing in the memory that optimizes queries that access the database, wherein the query optimizer rewrites a query as a join of a first sub-query and a second sub-query, wherein the first sub-query runs over a materialized query table (MQT) written over the base table and the second sub-query runs over a staging table for the base table.

6. The apparatus of claim 5 wherein the query optimizer stores information concerning the base table that includes a list of MQT names and a field for each MQT name to indicate whether changes to the MQT are tracked by the query optimizer.

7. The apparatus of claim 6 wherein the query optimizer stores information concerning the MQT that includes an MQT name, a time the MQT was last refreshed, a timestamp that indicates when the MQT is invalid, and a field to indicate the record count of the base table associated with the MQT when the MQT was last refreshed.

8. A method for a refreshing a materialized query table (MQT) in a database, the method comprising the steps of:
determining if an MQT exists for the query;
determining if the MQT is valid; and
rewriting the query as a join of a first sub-query and a second sub-query, wherein the first sub-query runs over a materialized query table (MQT) written over the base table and the second sub-query runs over the base table.

9. The method of claim 8 wherein the step of determining if the MQT is valid includes reading the value of an invalidate timestamp stored with the MQT.

10. The method of claim 8 wherein the step of determining if the MQT is valid includes setting the value of an invalidate timestamp stored with the MQT while processing update/changes to the at least one base table.

11. The method of claim 8 wherein the step of rewriting the query includes rewriting the query to join the results of the query run over the base table records that have a relative record number greater than the record count associated with the MQT when the MQT was last refreshed.

12. The method of claim 8 wherein the step of rewriting the query includes rewriting the query to join the results of the query run over a staging table with the results of the MQT.

13. A program product comprising:
(A) a query optimizer that optimizes queries that access a computer database having base table, and wherein the query optimizer rewrites a query as a join of a first sub-query and a second sub-query, wherein the first sub-query runs over a materialized query table (MQT) written over the base table and the second sub-query runs over the base table; and
(B) computer-readable signal bearing media bearing the query optimizer.

14. The program product of claim 13 wherein the computer-readable signal bearing media comprises recordable media.

15. The program product of claim 13 wherein the computer-readable signal bearing media comprises transmission media.

16. The program product of claim 13 wherein the query optimizer stores information concerning the base table that includes a list of MQT names and a field for each MQT name to indicate whether changes to the MQT are tracked by the query optimizer

17. The program product of claim 13 wherein the query optimizer stores information concerning the MQT that includes an MQT name, a time the MQT was last refreshed, a timestamp that indicates when the MQT is invalid, and a field to indicate the record count of the base table associated with the MQT when the MQT was last refreshed.

18. The program product of claim 13 wherein the query optimizer runs the query over the base table records that have a relative record number greater than the record count associated with the MQT when the MQT was last refreshed.
